(19) United States
(12) Patent Application Publication
(10) Pub. No.: US 2011/0320827 A1
(43) Pub. Date: Dec. 29, 2011

(54) System and Method for Identifying Power Connections in Computer Systems Having Redundant Power Supplies

(76) Inventors: Craig S. Siegman, Pembroke Pines, FL (US); Stephen D. Cochran, Cedar Peak, TX (US)

(21) Appl. No.: 12/822,755

(22) Filed: Jun. 24, 2010

(51) Int. Cl. G06F 1/26

(52) U.S. Cl. 713/300

(57) ABSTRACT

A Power Distribution Unit (PDU) control system controls a PDU and communicates with a server management controller of a server. Through its connections, the PDU control system can track and manage the power supplies and locations of servers connected to those power supplies. A PDU receives commands at its communications port from a PDU control system to shut down a power strip or power outlet to which the PDU is connected via one of plural power interfaces. In turn, a server's management controller detects when a power supply shuts down due to the shut down of the power strip or power outlet. The server's management controller can be either queried by the PDU control system or the controller can send a notification to the PDU control system indicating which power supply lost power, thereby correlating the power strip to the server.

### FIELD OF INVENTION

The present invention is directed to a system and method for identifying the power connections between a computer and remotely-controllable power distribution units (PDUs), and in one embodiment to a system and method for identifying the power connections between remotely-controllable PDUs and a computer having redundant power supplies.

### DISCUSSION OF THE BACKGROUND

Due to the number of cables between servers and various electrical connectors (e.g., power connectors of PDUs and data connectors) in computer farms, a significant amount of time and effort is required to track what cables interconnect what servers. Furthermore, as parts fail or as cables and connectors get reconfigured, there is a significant possibility that the information describing the connections can become out-of-date.

### BRIEF DESCRIPTION OF THE DRAWINGS

The following description, given with respect to the attached drawings, may be better understood with reference to the non-limiting examples of the drawings, wherein:

FIG. 1 is a block diagram of a power distribution unit control system interfacing with a server having redundant power supplies connected to separate power strips and a corresponding power distribution unit;

FIG. 2 is a block diagram of a power distribution unit control system interfacing with a server having redundant power supplies connected to separate power outlets and a corresponding power distribution unit;

FIG. 3 is a block diagram of a power distribution unit control system having an integrated power distribution unit and interfacing with a server having redundant power supplies connected to separate power outlets; and

FIG. 4 is a flowchart showing a process of correlating power strips or outlets to servers (and their locations).

### DISCUSSION OF THE PREFERRED EMBODIMENTS

Computer servers, power supplies and Power Distribution Units (PDUs) are all typically housed in a rack of equipment. It is desirable for management reasons for a server owner to know in which rack the server is located and to which PDU-controlled power supply or supplies it is connected. By observing the power going into the server, a PDU control system can automatically track a server's power connections and therefore location. By utilizing a server with dual power supplies and internal power-monitoring hardware, the server can detect the status of each of its power supplies as a PDU shuts down power strips or individually controlled power outlets. The server's management controller then determines if either of its power supplies has been shut down. If one of the power supplies has been shut down, then the PDU control system can record to which power supply the server is connected, and if it is known in which rack the PDU resides, it can also indicate in which rack the server is located.

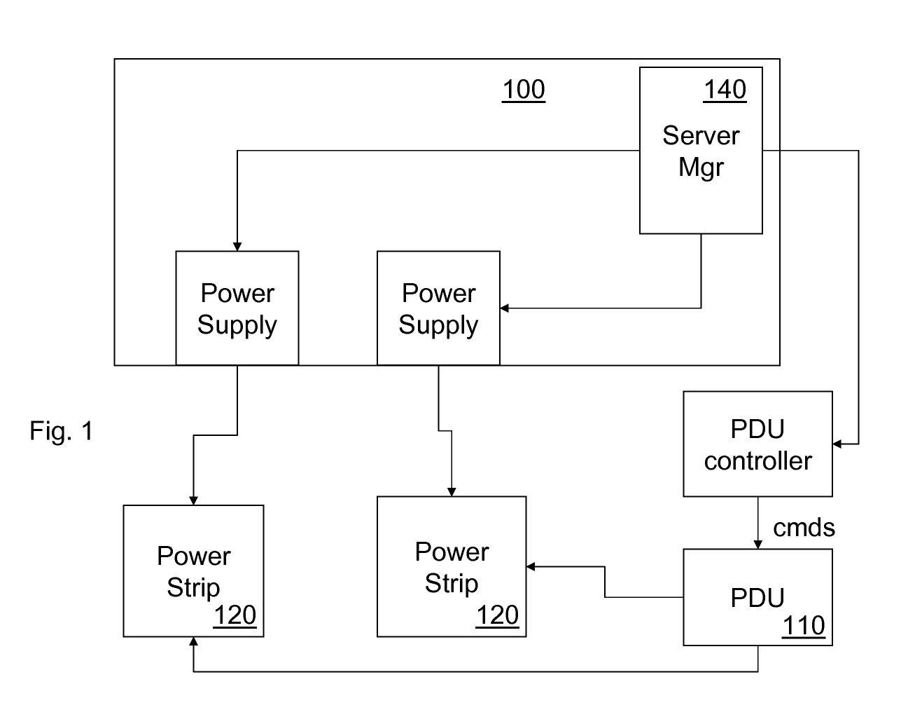

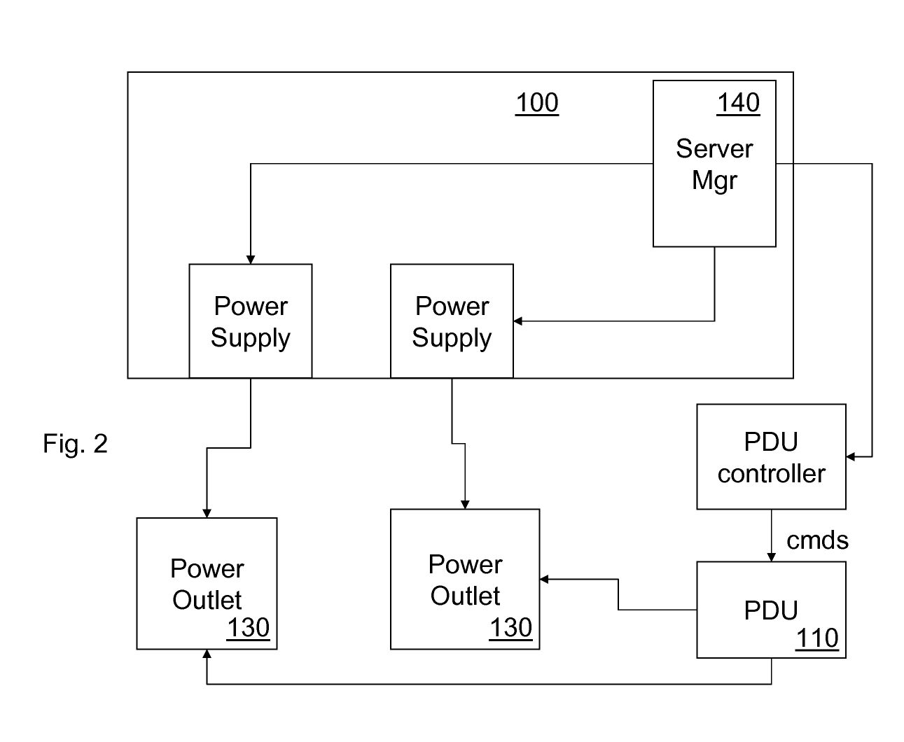

As shown in FIGS. 1 and 2, a PDU control system controls a PDU 110 and communicates with a server management controller 140 (e.g., an IPMI-controller) of a server 100. The PDU control system may be implemented as hardware (including a controller) or as a combination of hardware and software for controlling the hardware. In an embodiment using a combination of hardware and software, the software runs on a portion of the hardware (e.g., a processor acting as a controller) and is read into a digital memory (e.g., RAM) to control the operation of the controller. The software also controls a portion of the electrical signals being transmitted by the hardware in response to electrical signals being received by the hardware.

Through its connections, the PDU control system can track and manage the power supplies and locations of servers connected to those power supplies. The PDU 110 receives commands (e.g., at a communications port (e.g., a serial port, a wireless interface, an Ethernet port)) from a PDU control system to shut down a power strip 120 (FIG. 1) or power outlet 130 (FIG. 2) to which the PDU is connected via one of plural power interfaces. In turn, the software running on the server's management controller 140 (or the hardware of the server's management controller 140 itself) detects when a power supply shuts down due to the shut down of the power strip 120 or power outlet 130. The server's management controller 140 can be either queried by the PDU control system or the controller 140 can send a notification to the PDU control system indicating which power supply lost power. (Because management controllers are typically set to send fault notifications if a power supply loses power, the system may temporarily disable the normal notification during the location/connection tests in order to avoid “double reporting” the loss of power.) The server management information that the server management controller sends (or which can be queried by the PDU control system) preferably contains information that uniquely identifies the server, such as its serial number or MAC address.

The PDU control system can also determine if the two power supplies connected to a single server are being controlled by the same PDU. In that case, the PDU control system may advise a system administrator to change the power connections in order to increase power independence and redundancy.

Shutting down the power supply may involve shutting down all output voltages. Alternatively, if the power supply allows it, and if the server is otherwise operating normally, particular voltages of the power supply can be turned off so that only essential voltages are sent to the server, but the server management controller can detect the loss of one of the voltages. It is also possible to use the same technique with a single power supply if a non-essential voltage can be shut down and tolerated by the server and its management controller. For example, a power supply may supply +5V, +12V and −12V to a computer. If one of those voltages (e.g., −12V) is not essential, then loss of that voltage (−12 V) will not disrupt the overall operation of the computer but will allow the computer to detect the loss of one of its voltages which can be used to determine which power supply is connected to which connector or cable.

In yet another embodiment, an uninterruptable power supply may be interposed between an outlet and a server. In such a configuration, the uninterruptable power supply is also connected to a peripheral connector (e.g., a USB connector) of the server, and the uninterruptable power supply is configured to report the loss of power to the server across the peripheral connector (e.g., using USB-based messages).

Generally, by causing a measurable disturbance on a power supply, the PDU controlled power supply can be correlated with a particular server within a particular rack of equipment.

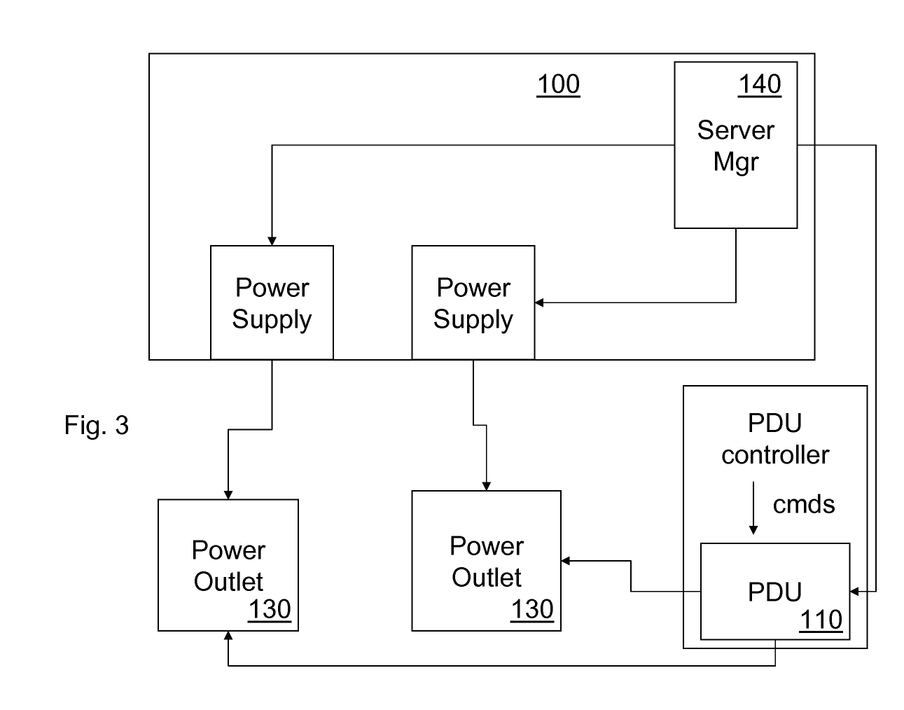

As shown in FIG. 3, a power distribution unit can be integrated into a PDU control system rather than externally connected thereto. In such a configuration, the PDU control system sends its commands internally to control the power strips and/or outlets. In such a configuration, the communications port may include an internal bus in addition to the other ports described above.

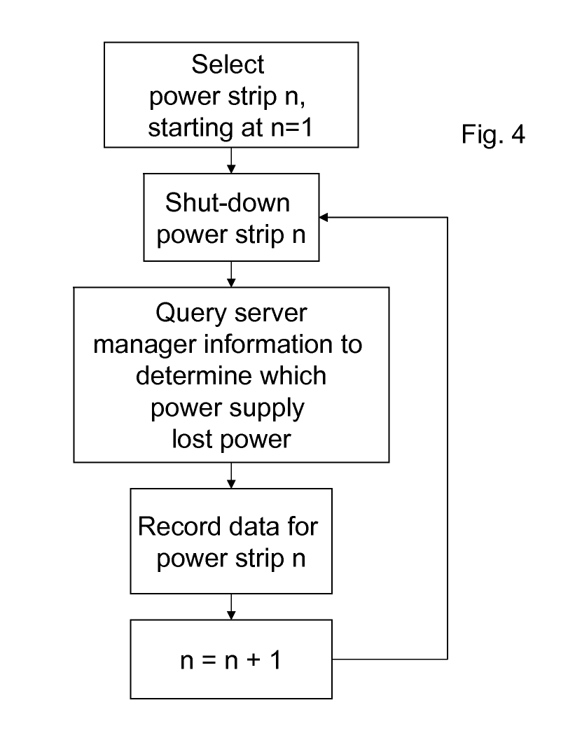

As shown in FIG. 4, a PDU control system iteratively controls one or more power distribution units to control a plurality of power strips or power outlets. According to the process, a first power strip (which generalizes to an individually controlled power outlet) of the PDU is selected, and the PDU shuts down the power strip. The server manager information of the servers is then examined (e.g., by querying individual server managers or processing incoming fault reports from server managers) to determine which power supply lost power. That power strip is then correlated to the server identified in the server manager information. The next power strip can then be selected, and the process can be repeated for all power strips. If a PDU control system controls more than one PDU, then the PDU control system can repeat the steps of FIG. 4 for each of the PDUs that it controls.

While certain configurations of structures have been illustrated for the purposes of presenting the basic structures of the present invention, one of ordinary skill in the art will appreciate that other variations are possible which would still fall within the scope of the appended claims. For example, while the above describes servers with redundant power supplies, it is to be understood that “servers” in intended to encompass other devices (e.g. computers generally) with redundant power supplies.

1. A power distribution unit control system, comprising:
plural power interfaces connectable to plural power strips, the plural power strips to be connected to plural servers, each of the plural servers having a server management controller and at least two power supplies;
a communications port for sending commands to shut down at least one power strip of the plural power strips;
a controller for receiving information from the server management controllers in response to the at least one power strip of the plural power strips shutting down and for correlating the corresponding server of the plural servers to the at least one power strip of the plural power strips.

2. The power distribution unit control system as claimed in claim 1, wherein the communications port comprises a serial port.

3. The power distribution unit control system as claimed in claim 1, wherein the communications port comprises a Universal Serial Bus (USB) port.

4. The power distribution unit control system as claimed in claim 1, wherein the communications port comprises an Ethernet port.

5. The power distribution unit control system as claimed in claim 1, wherein the plural power strips each comprise a single power outlet.

6. The power distribution unit control system as claimed in claim 1, wherein the controller further notifies a system administrator if more than one power supply of a server is connected to the same power strip.

7. The power distribution unit control system as claimed in claim 1, wherein the server management controller comprises an IPMI-controller.
